(19) United States
(12) Patent Application Publication
(10) Pub. No.: US 2009/0023040 A1
(43) Pub. Date: Jan. 22, 2009

(54) OXYGEN REMOVAL SYSTEMS DURING FUEL CELL SHUTDOWN

(75) Inventors: Chi Paik, Brownstown Twp., MI (US); James A. Adams, Ann Arbor, MI (US); George S. Saloka, Dearborn, MI (US); Mark S. Sulek, Sterling Heights, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/780,101

(22) Filed: Jul. 19, 2007

(51) Int. Cl. H01M 2/12

(52) U.S. Cl. 429/34

(57) ABSTRACT

A purging system for removing oxygen from a fuel cell system during a shutdown period for the fuel cell system. The purging system includes a separator having an inlet and an outlet; a first exhaust line for communicating a first exhaust gas stream from an outlet of the fuel cell system to the separator inlet during the shutdown period of the fuel cell system; and a second exhaust line for communicating a second exhaust gas stream to an inlet of the fuel cell system for delivering the second exhaust gas stream to the fuel cell system during the shutdown period. The separator removes oxygen from the first exhaust gas stream such that the first stream nitrogen molar volume is lower than the second steam nitrogen molar volume and the first stream oxygen molar volume is higher than the second stream oxygen molar volume.

### BACKGROUND OF THE INVENTION

1. Technical Field

One aspect of the present invention relates to oxygen removal systems for fuel cells during shutdown. Another aspect of the present invention relates to oxygen introduction prevention systems for fuel cells during shutdown.

2. Background Art

Fuel cells are electrochemical devices that convert the chemical energy of a fuel into electricity and heat without fuel combustion. In the one type of fuel cell hydrogen gas and oxygen gas are electrochemically combined to produce electricity. The hydrocarbon used in this process may be obtained from natural gas or methanol while air provides the oxygen source. The only by products of this process are water vapor and heat. Accordingly, fuel cell-powered electric vehicles reduce emissions and the demand for conventional fossil fuels by eliminating the internal combustion engine (e.g., in completely electric vehicles) or operating the engine at only its most efficient/preferred operating points (e.g., in hybrid electric vehicles). However, while fuel cell-powered vehicles have reduced harmful vehicular emissions, they present other drawbacks.

PEM fuel cells comprise an anode and a cathode which are separated by a polymeric electrolyte or proton exchange membrane (“PEM”). Each of the two electrodes may be coated with a thin layer of platinum. At the anode, the hydrogen is catalytically broken down into electron and hydrogen ions. The electrons provide the electricity as the hydrogen ions move through the polymeric membrane toward the cathode. At the cathode, the hydrogen ions combine with oxygen from the air and electrons to form water.

### SUMMARY

According to one aspect of the present invention, during shutdown of a PEM fuel cell, purging oxygen from the fuel cell can minimize hydrogen and oxygen mixing during startup of the fuel cell, which can increase the lifetime of the fuel cell. According to another aspect of the present invention, the lifetime of a PEM fuel cell can be increased by preventing the introduction of oxygen into the fuel cell during shutdown so that hydrogen and oxygen mixing during startup is minimized.

According to one embodiment of the present invention, a purging system for removing oxygen from a fuel cell system during a shutdown period for the fuel cell system is disclosed. The purging system includes a separator having an inlet and an outlet; a first exhaust line for communicating a first exhaust gas stream from an outlet of the fuel cell system to the separator inlet during the shutdown period of the fuel cell system; and a second exhaust line for communicating a second exhaust gas stream to an inlet of the fuel cell system for delivering the second exhaust gas stream to the fuel cell system during the shutdown period. The first exhaust gas stream includes oxygen at a first oxygen molar volume and nitrogen a first nitrogen molar volume. The second exhaust gas stream includes oxygen at a second oxygen molar volume and nitrogen at a second nitrogen molar volume. The separator removes oxygen from the first exhaust gas stream such that the first nitrogen molar volume is lower than the second nitrogen molar volume and the first oxygen molar volume is higher than the second oxygen molar volume.

### BRIEF DESCRIPTION OF THE DRAWING

FIG. 1 depicts a system including a fuel cell and a separator according to one embodiment of the present invention;

FIG. 2 depicts a system including a fuel cell, a separator, and an oxygen depleted air storage device according to another embodiment of the present invention;

FIG. 3 depicts a system for preventing the introduction of oxygen into the fuel cell during shutdown according to an embodiment of the present invention; and

FIGS. 4A, 4B, 4C and 4D depict polarization curves for quantifying fuel cell degradation under specified experimental conditions.

### DETAILED DESCRIPTION OF EMBODIMENTS OF THE PRESENT INVENTION

Except where expressly indicated, all numerical quantities in this description indicating amounts of material or conditions of reaction and/or use are to be understood as modified by the word “about” in describing the broadest scope of the present invention. Practice within the numerical limits stated is generally preferred.

The description of a single material, compound or constituent or a group or class of materials, compounds or constituents as suitable for a given purpose in connection with the present invention implies that mixtures of any two or more single materials, compounds or constituents and/or groups or classes of materials, compounds or constituents are also suitable. Also, unless expressly stated to the contrary, percent, “parts of,” and ratio values are by volume. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The lifetime of a proton exchange membrane (“PEM”) fuel cell can be shortened by exposure to air during the transition of the PEM fuel cell from off to a startup. As applied to automotive vehicles, this transition is commonly referred as vehicle startup. During vehicle startup, if hydrogen fuel is introduced into the anode that is exposed to air, the simultaneous mixing of hydrogen and oxygen within the anode layer may cause local potential gradients within the same catalyst layer, which may degrade the catalyst, the catalyst support, and/or the membrane. In certain applications, degradation is a predominant problem in the cathode catalyst layer.

Each fuel cell cycle, i.e. a cycle including the transition between idle and start up, can present an opportunity in which the simultaneous mixing of hydrogen and oxygen may occur, thereby contributing to the degradation of the fuel cell. According to conventional systems, the problem of simultaneous mixing of any oxygen with hydrogen was identified as substantially degrading the fuel cell over time.

Embodiments of the present invention include the discovery of the problem of having the simultaneous mixing of greater than 5% oxygen in air and balance hydrogen, as supported by the experimental data presented here. Unexpectedly, insignificant degradation occurs when cycling includes the simultaneous mixing of 0-5% oxygen in air and hydrogen. Therefore, embodiments of the present invention provide a new solution to a new problem.

In light of the foregoing, an oxygen removal system is needed for minimizing the scenario of hydrogen and air mixing in the same catalyst compartment. What is also needed is a method for preventing catalyst exposure to oxygen in the fuel cell during shutdown.

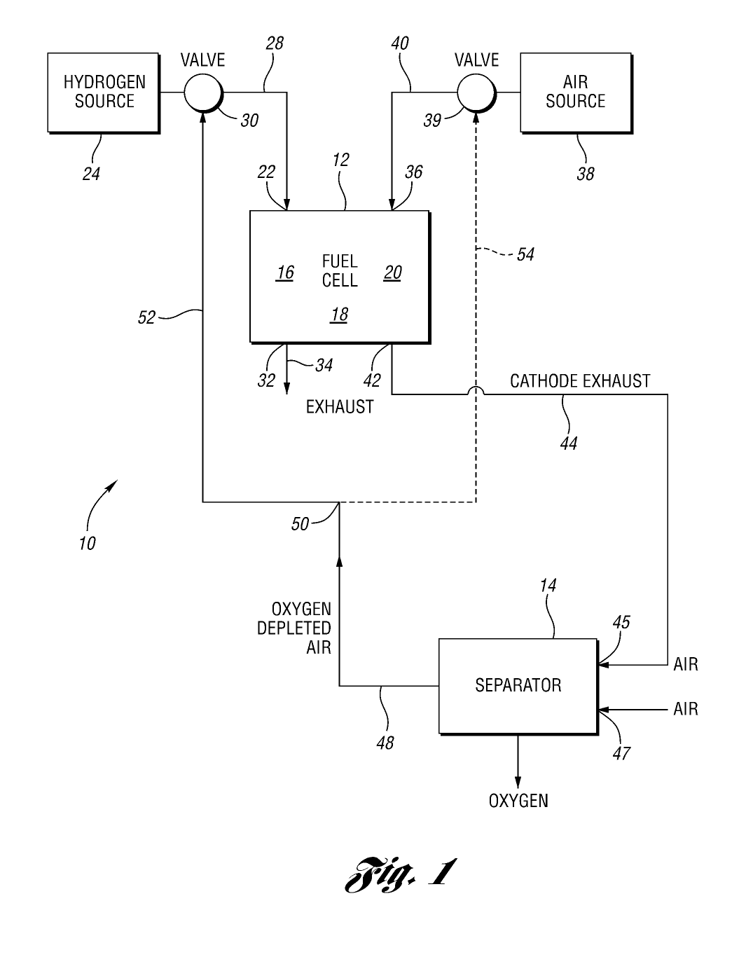

FIG. 1 depicts a system 10 including a fuel cell 12 and a separator 14, according to one embodiment of the present invention. The fuel cell 12 includes an anode compartment 16, an electrolyte compartment 18, and a cathode compartment 20. The electrolyte compartment 18 is disposed between the anode compartment 16 and the cathode compartment 20. In at least one embodiment, the fuel cell 12 is a proton exchange membrane (PEM) fuel cell. As known in the art, the PEM fuel cell transforms chemical energy liberated during the reaction of hydrogen (H₂) and oxygen (O₂) to electrical energy.

In one embodiment of the present invention, the fuel cell 12 performs this transformation during an operational mode, i.e., an “on” mode. During the operational mode, a hydrogen stream is fed into the anode compartment 16 through an anode inlet 22. A hydrogen fuel source 24 for the hydrogen stream can be produced by a hydrogen generator. The system 10 includes an anode inlet line 28 situated between the hydrogen fuel source outlet 26 and the anode inlet 22. The hydrogen fuel source travels through the inlet line 28 as the hydrogen stream, which is fed into the anode compartment 16 through the anode inlet 22.

A hydrogen stream valve 30 is positioned on inlet line 28 to control the supply of the hydrogen stream to the anode compartment 16. During the operational mode, the hydrogen valve 30 is at least partially open to allow the hydrogen stream to flow into the anode compartment 16. During a shutoff mode, i.e., the time period in which the fuel cell 12 is not operating, and otherwise referred to as the “off” mode, the hydrogen stream valve 30 is closed to prevent the flow of hydrogen into the anode compartment 16.

During the operation mode, the hydrogen introduced into the anode compartment 16 is catalytically split into protons and electrons. Excess hydrogen fuel exits the anode compartment 16 through an anode outlet 32 to the anode exhaust line 34. The newly formed protons permeate the electrolyte compartment 18 to the cathode compartment 20. The electrons travel along an external load circuit (not shown) to the cathode compartment 20, thereby creating a current output of the fuel cell 12.

During the operational mode, an air stream including oxygen and nitrogen is fed into the cathode compartment 20 through a cathode inlet 36. An air source 38 can be an atmospheric source in which air is supplied through a cathode inlet line 40 to the cathode inlet 36 for use within the cathode compartment 20. An air stream valve 39 is positioned on inlet line 40 to control the supply of air to the cathode compartment 20.

The oxygen in the air stream reacts with the protons permeating through the electrolyte compartment 18 and the electrons arriving through the external circuit (not shown) to form water molecules. The water molecules and heat exit the cathode compartment 20 through a cathode outlet 42 to the cathode exhaust line 44.

In one embodiment of the present invention, the separator 14 is positioned at the end of the cathode exhaust line 44. In at least one embodiment, the separator 14 includes a cathode exhaust input 45 for receiving the cathode exhaust in the cathode exhaust line 44. In another embodiment, the separator 14 includes an atmospheric air inlet 47 for receiving air from the atmosphere. In yet another embodiment, the separator 14 includes both inputs 45 and 47.

During the shutoff period, the separator 14 can be utilized to remove oxygen from the cathode exhaust line 44 (and/or atmospheric air fed from the atmospheric air inlet), which exits the separator 14 through oxygen outlet line 46, and to produce a nitrogen-rich gas stream (otherwise referred to as an oxygen depleted gas stream), which exits the separator 14 through outline line 48. The nitrogen-rich gas stream can be fed to a junction 50, which allows the nitrogen-rich gas to flow into the anode return line 52 and cathode return line 54. The anode return line 52 is connected to valve 30 and the cathode return line is connected to valve 39, according to at least one embodiment. Non-limiting examples of junctions include orifices and/or pipes. In another embodiment, the system 10 does not include a junction 50, and all of the nitrogen-rich gas travels through anode return line 52. This embodiment is signified by dotted line 54.

During the shutoff period, valves 30 an/or 39 are in a position to allow the flow of nitrogen-rich gas into the anode inlet line 28 and the cathode inlet 40. The nitrogen-rich gas then flows into the anode and cathode compartments 16 and 20 from the anode inlet line 28 and/or the cathode inlet 40, thereby removing air from the fuel cell 12 through anode and cathode exhaust lines 34 and 42. This purging of nitrogen-rich gas into the fuel cell 12 during shutdown ameliorates the mixing of oxygen and hydrogen at startup. The nitrogen purge minimizes simultaneous mixtures of hydrogen and oxygen within the same catalyst layer of the fuel cell 12.

In at least one embodiment, the nitrogen molar volume % in the nitrogen-rich gas stream is 80 to 100%. In another embodiment, the nitrogen molar volume % in the nitrogen-rich gas stream is 91 to 100%. In yet another embodiment, the nitrogen molar volume % in the nitrogen-rich gas stream is 95% to 100%. In one embodiment, the nitrogen molar volume % in the nitrogen-rich gas stream is 99% to 100%.

In at least one embodiment, the oxygen molar volume % in the nitrogen-rich gas stream is 0 to 20%. In another embodiment, the oxygen molar volume % in the nitrogen-rich gas stream is 0 to 9%. In yet another embodiment, the oxygen molar volume % in the nitrogen-rich gas stream is 0% to 5%. In one embodiment, the oxygen molar volume % in the nitrogen-rich gas stream is 0% to 1%.

In at least one embodiment, the ratio of nitrogen molar volume in the cathode exhaust line 44 to the oxygen depleted air line 48 is in the range of 80:81 to 80:100 and the ratio of oxygen molar volume in the cathode exhaust line 44 to the oxygen depleted air line 48 is in the range of 20:19 to 0.

In at least one embodiment, the separator 14 is an oxygen separating chamber, and in other embodiments, the separator 14 is a nitrogen generator. In certain embodiments, the present invention utilizes the nitrogen generator uniquely to automotive fuel cell applications with any adaptations necessary.

In at least one embodiment, the separator 14 is a molecular sieve. In one embodiment, a molecular sieve available from Universal Industrial Gases, Inc., Easton, Pa. is utilized. Examples of adsorbent materials that can be utilized in the molecular sieve, include, but are not limited to, aluminosilicate minerals, clays, porous glasses, microporous charcoals, zeolites, active carbons, and/or synthetic compounds that have open structures through which small molecules, such as nitrogen can diffuse. In at least one embodiment, the molecular sieve can be regenerated during the operational period via a chamber regenerator 58. Non-limiting examples of chamber regenerators 58 include exhaust heat from the fuel cell 12, a nitrogen carrier gas, or dilute hydrogen bleed or vacuum.

In other embodiments, oxygen removal can be achieved by pressure swing adsorption. In one embodiment, a unit for pressure swing adsorption is the Parker-Balston High Flow Nitrogen Generator Model AGS200. U.S. Pat. Nos. 4,440,548 and 4,439,213 disclose examples of pressure swing adsorption, and are incorporated herein in their entirety. In yet other embodiments, a membrane separation device can be utilized for oxygen removal from the anode exhaust line 34 during the shutoff mode. In one embodiment, nitrogen membrane systems available from Universal Industrial Gases, Inc. are utilized. In other embodiments, the Parker-Balston Model N2-80 can be utilized. U.S. Pat. Nos. 5,439,507 and 5,302,189 disclose examples of membrane separation devices, and are incorporated herein in their entirety.

In at least one embodiment, the gas content within the fuel cell 12 can be circulated through the separator 14 during the shutoff mode. The circulation can be provided through the cathode exhaust line 44 and the anode return line 52 and/or the cathode return line 54. Increasing the circulation time can increase the removal of oxygen from the fuel cell 12 during the shutoff mode, thereby minimizing the amount of oxygen present in the fuel cell 12 during the startup mode. In at least one embodiment, the circulation time can encompass the entire shutdown period.

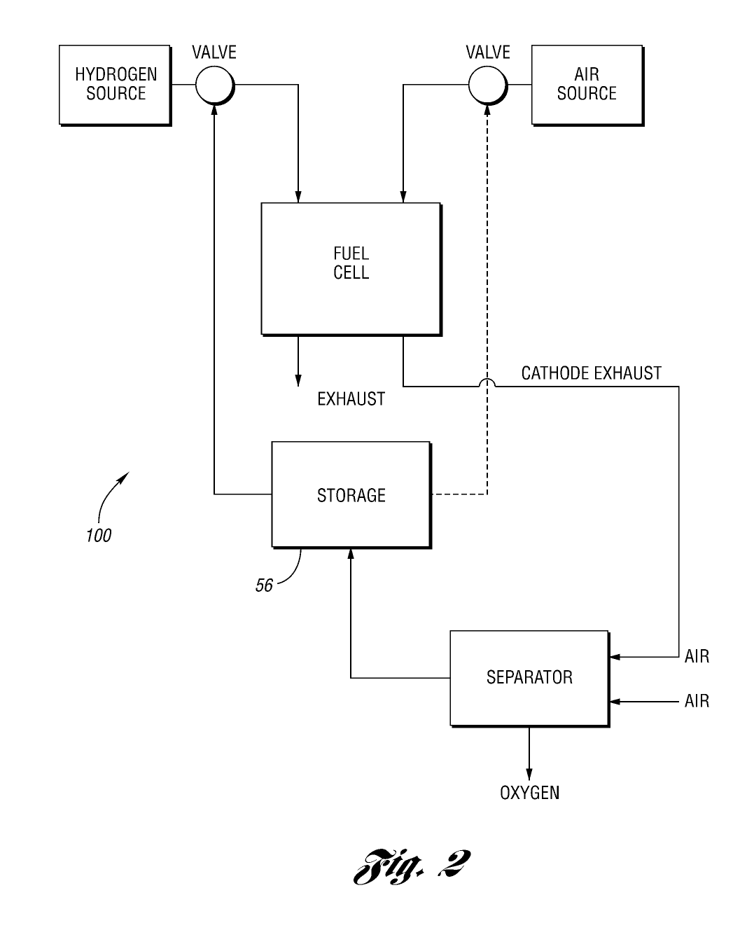

In yet another embodiment of the present invention, as depicted in FIG. 2, a system 100 including a storage device 56, e.g. a tank with a check valve, can be utilized. The storage device 56 can store nitrogen-rich air during shutdown, which can be purged into the fuel cell 12 through the anode inlet line 28 and/or cathode inlet line 40. In at least one embodiment, the purging occurs just prior to startup of the fuel cell 12.

In another embodiment, during operation of the fuel cell 12, the separator 14 can produce an oxygen depleted air stream from atmospheric air being fed through the atmospheric air inlet 47. The oxygen depleted air stream can be stored in the storage device 56 for use in the purging operation during shutoff.

In at least one embodiment, the nitrogen molar volume % of the stored oxygen depleted air is 80 to 100%. In another embodiment, the nitrogen molar volume % of the stored oxygen depleted air is 91 to 100%. In yet another embodiment, the nitrogen molar volume % of the stored oxygen depleted air is 95% to 100%. In one embodiment, the nitrogen molar volume % of the stored oxygen depleted air is 99% to 100%.

In at least one embodiment, the oxygen molar volume % of the stored oxygen depleted air is 0 to 20%. In another embodiment, the oxygen molar volume % of the stored oxygen depleted air is 0 to 9%. In yet another embodiment, the oxygen molar volume % of the stored oxygen depleted air is 0% to 5%. In one embodiment, the oxygen molar volume % of the stored oxygen depleted air is 0% to 1%.

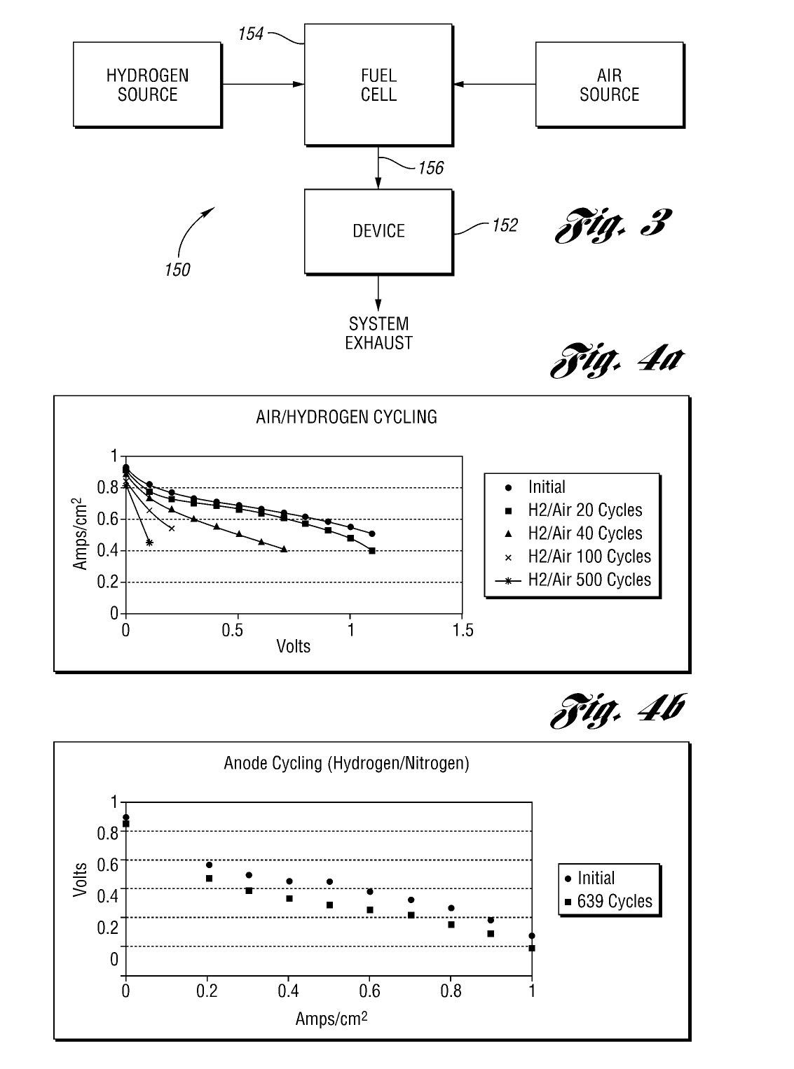

FIG. 3 depicts a system 150 according to the present invention in which air introduction into the fuel cell 12 is prevented during shutdown via a device 152, for example, a mechanical device (e.g., check valve) or chemical means (e.g., oxygen scavenger).

During the transition between the operational mode and the shutoff mode, otherwise referred to as the shutdown mode, oxygen may leak back into the fuel cell 154 and the anode and cathode compartments, through outlet line 156 (collectively referring to the anode and/or cathode outlet lines). Furthermore, the oxygen can become trapped in the anode exhaust line and/or cathode exhaust line. This trapped oxygen may leak into the anode and/or cathode compartments during the shutoff period. During the transition between the shutoff mode and the operational mode, the oxygen that leaked into one or both of the compartments during shutoff may simultaneously mix with the hydrogen entering through the anode inlet 158. This mixing of hydrogen and oxygen within the anode compartment 16 may lead to local potential gradients within the same electrode, which may attack the catalyst and catalyst support within the anode compartment 16 and/or cathode compartment 18, as well as the electrolyte compartment 18. The device 152 prevents or at least minimizes the reintroduction of oxygen into the fuel 154 during shutdown.

### EXPERIMENTAL DATA

A test stand was constructed for cycling various gases through a fuel cell for different time periods. Air, air/nitrogen mixtures, hydrogen, and nitrogen enter the system through pneumatically controlled valves that can be programmed to open and close to control the type of gas flowing to the fuel cell. Three gas mixtures were selected for this experiment (i) 21% oxygen (100% air), 5% oxygen/95% nitrogen, and 10% oxygen/90% nitrogen. All gas pressures were 10 psig and flowed at a rate of 800 sccm (“Standard Cubic Centimeters per Minute”). All gas cycles consisted of a 60 second “on” and a 60 second “off” time. Following each gas cycle, polarization curves were completed to quantify MEA (membrane electrode assembly) degradation.

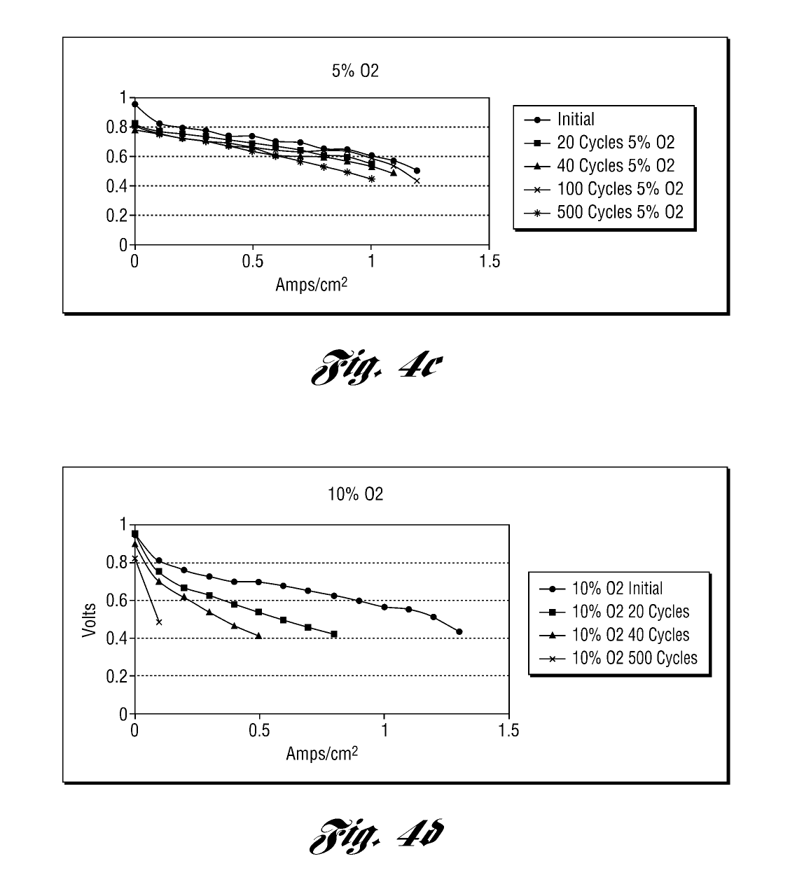

FIGS. 4A, 4B, 4C and 4D illuminate the degradation effects of cycling the anode gas. FIG. 4A indicates minimal cell performance degradation. FIG. 4B is a typical representation of cell degradation observed when cycling the anode between air and hydrogen. The loss in cell performance is significant after 20 cycles of hydrogen to air. Cycling the anode between a gas mixture of 5% oxygen in air and hydrogen (FIG. 4C) demonstrates an insignificant loss in performance similar to FIG. 4A. FIG. 4D demonstrated that cycling between 10% oxygen in air and hydrogen degrades the cell performance in a similar fashion as when cycling between air and hydrogen. The polarization curve data indicates that using an oxygen depleted gas to purge the anode during shutdown can be as beneficial as using a 100% nitrogen gas as the purge gas.

As required, detailed embodiments of the present invention are disclosed herein. However, it is to be understood that the disclosed embodiments are merely exemplary of an invention that may be embodied in various and alternative forms. While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

In accordance with the provisions of the patent statute, the principle and mode of operation of this invention have been explained and illustrated in its various embodiments. However, it must be understood that this invention may be practiced otherwise than as specifically explained and illustrated without departing from its spirit or scope.

What is claimed is:

1. A purging system for removing oxygen from a fuel cell system during a shutdown period for the fuel cell system, the purging system comprising:
a separator having an inlet and an outlet;
a first exhaust line for communicating a first exhaust gas stream from an outlet of the fuel cell system to the separator inlet during the shutdown period of the fuel cell system, the first exhaust gas stream including oxygen at a first oxygen molar volume and nitrogen a first nitrogen molar volume; and
a second exhaust line for communicating a second exhaust gas stream to an inlet of the fuel cell system for delivering the second exhaust gas stream to the fuel cell system during the shutdown period, the second exhaust gas stream including oxygen at a second oxygen molar volume and nitrogen at a second nitrogen molar volume,
the separator removing oxygen from the first exhaust gas stream such that the first nitrogen molar volume is lower than the second nitrogen molar volume and the first oxygen molar volume is higher than the second oxygen molar volume.

2. The purging system of claim 1, wherein the second exhaust gas stream is purged into the fuel cell to displace oxygen residing in the fuel cell during the shutdown period.

3. The purging system of claim 2, wherein the second nitrogen molar volume % is in the range of 81 to 100% so as to remove oxygen residing in the fuel cell during the shutdown period when the second exhaust gas stream is purged into the fuel cell during shutdown.

4. The purging system of claim 2, wherein the second nitrogen molar volume % is in the range of 95 to 100% so as to displace oxygen residing in the fuel cell during the shutdown period when the second exhaust gas stream is purged into the fuel cell during shutdown.

5. The purging system of claim 1, wherein the separator is a nitrogen generator for removing oxygen from the first exhaust gas stream.

6. The purging system of claim 1, wherein the separator is a oxygen separating device for removing oxygen from the first exhaust gas stream.

7. The purging system of claim 1, wherein the second exhaust line includes an anode return line portion coupled to the fuel cell anode for purging the second exhaust gas into the fuel cell during shutdown.

8. The purging system of claim 7, wherein the second exhaust line includes a cathode return line portion coupled to the fuel cell cathode for purging the second exhaust gas into the fuel cell during shutdown.

9. The purging system of claim 1, wherein the separator includes an atmospheric air inlet for receiving atmospheric air.

10. The purging system of claim 1, wherein the separator is a membrane separation device or a pressure swing adsorption device for removing oxygen from the first exhaust gas stream.

11. The purging system of claim 6, wherein the oxygen separating device is a molecular sieve for removing oxygen from the first exhaust gas stream.

12. The purging system of claim 1, further comprising a circulation device for circulating the gas positioned within the fuel cell system during the shutdown period through the separator for removing oxygen from the gas positioned within the fuel cell system.

13. The purging system of claim 11, the fuel cell system operating during a startup period following the shutdown period and an operational period following the startup period, and further comprising a regenerator for regenerating the molecular sieve during the operational period.

14. The purging system of claim 1, wherein the fuel cell system inlet is configured for continuous or pulsed delivery of the second exhaust gas stream to the fuel cell.

15. A purging system for removing oxygen from a fuel cell system during a shutdown period for the fuel cell system, the purging system comprising:
a separator having an inlet and an outlet;
a first line for communicating a first gas stream into the separator inlet, the first gas stream including oxygen at a first oxygen molar volume and nitrogen a first nitrogen molar volume;
a storage device for storing gas, the storage device having an inlet and an outlet;
a second line for communicating a second gas stream to the storage device inlet for storing the second gas in the storage tank for use in purging the fuel cell system during the shutdown period, the second gas stream including oxygen at a second oxygen molar volume and nitrogen at a second nitrogen molar volume; and
a third line for communicating the stored second gas stream to an inlet of the fuel cell system for delivering the second gas stream to the fuel cell system during the shutdown period,
the separator removing oxygen from the first exhaust gas stream such that the first nitrogen molar volume is lower than the second nitrogen molar volume and the first oxygen molar volume is higher than the second oxygen molar volume during the shutdown period.

16. The purging system of claim 15, wherein the separator includes an atmospheric air inlet for receiving atmospheric air.

17. The purging system of claim 15, wherein the separator is capable of producing the second gas stream during the shutdown period and the operation of the fuel cell, and the storage tank is capable of storing the second gas stream at least during the shutdown period.

18. The purging system of claim 15, wherein the third line includes an anode return line portion coupled to the fuel cell anode for purging the second gas into the fuel cell during shutdown.

19. An introduction prevention system for preventing the introduction of oxygen into the fuel cell system during a shutdown period, the system comprising:
an exhaust line in communication with the fuel cell system outlet; and
a mechanism having an inlet and an outlet and situated on the exhaust line, the mechanism minimizing introduction of oxygen into the fuel cell system through the exhaust line during a shutdown period.

20. The reintroduction prevention system of claim 19, wherein the mechanism is a check valve or an oxygen scavenger.
